(19) United States
(12) Patent Application Publication
(10) Pub. No.: US 2002/0067845 A1
(43) Pub. Date: Jun. 6, 2002

(54) Sensor apparatus and method for use in imaging features of an object

(76) Inventor: Andrew J. Griffis, Tucson, AZ (US)

Correspondence Address: Lawrence R. Oremland, P.C., Suite C-214, 5055 East Broadway Blvd., Tucson, AZ, 85711, US

(21) Appl. No.: 10/005,028

(22) Filed: Dec. 4, 2001

Related U.S. Application Data
(60) Provisional application No. 60/256,499, filed on Dec. 5, 2000.

(51) Int. Cl. G06K 9/00

(52) U.S. Cl. 382/107

(57) ABSTRACT

A sensing device and method for use in imaging surface features of an object is provided. A surface along which an object can slide in a predetermined direction includes an array of contact sense elements configured to form a single array oriented transverse to the predetermined direction and at least one additional contact sense element located in spaced relation to the single array in a manner that enables a velocity measurement of the object in the predetermined direction. A scanning device is configured to provide a periodic scan of the array of contact sense elements, and a processor in circuit communication with the scanning device is configured to receive data from the scanning device and to produce image and velocity data related to the object. Preferably, the contact sense elements are electrically conductive elements disposed on a ceramic or polymeric substrate, using printed circuit board construction. A technique is described that enables the reconstruction of an object from such a device

### Related Application/Claim of Priority

This application is related to and claims priority from Provisional Application Ser. No. 60/256,499, filed Dec. 5, 2000.

### Technical Field

The present invention relates to a sensor device and method for use in imaging features of an object, e.g. a person's fingerprint.

### Background

There are currently three major approaches to so-called live scan fingerprint readers: 1) visible light optical, 2) silicon-based capacitive sensors, and 3) silicon-based thermal-infrared (IR) sensors.

The visible light optical sensors rely on the exploitation of the air-tissue index of refraction differential by imaging the finger near the critical angle for the finger placed on the imaging contact surface.

The silicon-based sensors, which rely on measurements of the fingerprint capacitance as a function of location on the finger, follow one of two general approaches. One approach involves measuring the discharge behavior of an array of charged electronic elements, thereby deriving the spatial dependence of capacitance from the underlying change in tissue/air dielectric constant. In terms of the electronic signal processing involved, this is an incoherent approach that measures the movement of charge under the influence of an applied field and in proximity to a dielectric material (i.e., a capacitor).

Another approach to a silicon based sensor uses a coherent approach to measuring the difference in dielectric constant between the ridge and nonridge portion of a fingerprint. It is known that the phase of an electromagnetic wave will vary proportionately with the dielectric constant of the medium of propagation for a fixed distance of propagation. Consequently, by modulating the finger tissue with a radio frequency (RF) signal and then detecting this signal after traversing the epidermis by demodulating the phase-delayed RF signal with a copy of the non-delayed signal (i.e., heterodyne detection) and extracting the phase and amplitude information, the spatial dependence of the dielectric constant across the finger can be determined in terms of the measured electric fields.

For thermal-IR fingerprint scanners, there are basically two approaches being used. One approach uses a two-dimensional thermal imager with which the fingerprint is imaged via direct contact and which requires the user to “swipe” the finger. As the finger is “swiped” multiple images of the fingerprint are gathered and can then be used to reconstruct a complete fingerprint image. The other approach uses thermal imaging in conjunction with thin film transistor (TFT) technology. In some embodiments, it uses a thermally sensitive photoemissive polymeric layer and images the fingerprint with conventional visible optics. In other embodiments, it directly couples the photoemissive layer to a TFT array, resulting in more highly integrated fingerprint scanner.

Both of the foregoing thermal imaging approaches rely on passive sensing (no external stimulus) of the finger tissue emissivity in the thermal-IR wavelengths. In both situations, the differential emissivity of the fingerprint ridge structure is the observable of interest.

There are principally two advantages that the silicon-based sensors bring to the fingerprint identification market that are not available from optical solutions: size and sensitivity. The silicon-based sensors are all near or below 2 mm thickness, and have sensor areas of less than 300 mm², so that the volume occupied by the sensor contact area and its associated imaging electronics is often an order of magnitude smaller in volume than an optical solution. Furthermore, since the optical solutions use visible light and respond only to the outer surface of the finger in contact with the contact area, and since the silicon-based techniques rely on physical properties of the fingerprint that go below the outermost skin cells, the silicon-based technologies are better able to image dry, wet or reduced-ridge scenarios when the optical approach might fail.

Areas of weakness with silicon sensors are 1) ruggedness, 2) susceptibility to electrostatic discharge (ESD), 3) susceptibility to contamination, and 4) cost. In traditional semiconductor applications, the first three issues are addressed by encasing the die in a rugged package made of plastic or ceramic, adding protective diodes and resistors around active elements, and by adding protective passivation layers to the die surface at the end of the die formation process. The fourth is addressed by scaling the circuit element to ever smaller sizes, thereby reducing the die size.

However, when using silicon sensors for measuring fingerprints, the measures used in traditional semiconductor manufacturing to mitigate such weaknesses of silicon are in conflict with optimal fingerprint imaging. The ideal fingerprint sensor minimizes the protective layer over the silicon, as the larger this layer is, the less sensitivity and resolution one can attain. Likewise, the ESD and contamination mitigation would call for significant encasement of the silicon, in conflict with the need to minimize the encasement over the silicon that will come in contact with the finger. Finally, the usual method for reducing cost in silicon, reducing overall die size by scaling down the size of the components built into the silicon, cannot be used, as the performance of the sensor will be directly impacted by the total area available for capturing a fingerprint. Thus, tradeoffs are required when making a silicon sensor for imaging a fingerprint, and these necessarily inhibit optimum sensor performance.

U.S. Pat. No. 6,289,114 (Mainguet) purports to disclose swipe-style fingerprint sensors. However, the present invention is distinct from Mainguet in a number of important ways. For example, Mainguet discloses sensors using silicon based sensor substrates, and, as discussed above, applicant believes there are areas of weakness connected with silicon based sensors. Additionally, Mainguet discloses a matrix of sensing elements and a reconstruction technique that relies on overlap of partial images, and the present invention is fundamentally different from both of those concepts.

### Summary of the Present Invention

The present invention provides a new and useful sensing device and method for use in imaging an object such as a person's fingerprint. The present invention provides a sensing device and method specifically designed to address the types of issues (e.g. ruggedness, ESD susceptibility, contamination and cost) which are often associated with silicon based sensors.

Moreover, the present invention also has a fundamentally different concept and structure for sensing and reconstructing an image than that of Mainguet. For example, whereas Mainguet relies on a matrix of sensing elements and a reconstruction technique that utilizes overlap of partial images, the present invention provides a single array of contact sense elements and at least one additional contact sense element which enables a velocity measurement, and reconstructs an image from the single array of contact sense elements and the velocity measurement. Moreover, whereas Mainguet uses silicon based sensor structure, the preferred embodiment of the present invention provides contact sensors on a printed circuit board (PCB) type of substrate (e.g. a ceramic or polymeric substrate).

According to the present invention, a sensing device for use in imaging surface features of an object comprises

a. a surface configured to enable an object to slide thereon in a predetermined direction,

b. an array of contact sense elements disposed on the surface, and configured to form (i) a single array of contact sense elements oriented transverse to the predetermined direction and (ii) at least one additional contact sense element located in spaced relation to the single array in a manner that enables a velocity measurement of the object in the predetermined direction,

c. a scanning device configured to provide a periodic scan of the array of contact sense elements, and

d. a processor in circuit communication with the scanning device and configured to receive data from the scanning device and to produce image and velocity data related to the object.

According to the preferred embodiment, the sensor uses printed circuit board (PCB) technology, in which the contact sense elements comprise electronically conductive elements disposed on a polymeric (e.g. fiberglass) or ceramic substrate. The PCB technology can include both rigid and flexible substrates to enable the use of the invention in a wide variety of applications that may benefit from a sensor that is conformal to the device (e.g., handheld computer, or telephony device) of which it is a part.

The principles of the present invention are believed to be particularly useful in forming a sensor for use in fingerprint identification for purposes such as access control, time/attendance, internet technology (IT) applications (i.e., password replacement), SmartCard applications, residential access control and personal identification devices for automotive and related markets, and other security or identification applications.

Other features of the present invention will become further apparent from the following detailed description and the accompanying drawings.

### Brief Description of the Drawings

FIG. 1 is a schematic illustration of an array of contact sensor elements configured for use in a system and method according to the present invention; and

FIG. 2 is a schematic illustration of one form of circuit for use in a system and method according to the principles of the present invention, and representing an incoherent signal processing technique;

FIG. 3 is a schematic illustration of another form of circuit for use in a system and method according to the principles of the present invention, and representing a coherent signal processing technique;

FIG. 4 schematically illustrates the top of a finger which is sliding along a surface toward an array of contact sensors configured to sense the bottom surface configuration of the finger, in accordance with the principles of the present invention;

FIG. 5 schematically illustrates the bottom surface configuration of the finger of FIG. 4, which slides across the array of contact sense elements, and is reproduced in accordance with the present invention; and

FIG. 5 plots capacitance of contact sense elements A and B of FIG. 4, as the finger slides across the contact sense elements.

### Detailed Description

As described above, the present invention relates to a sensing device and method which is designed to be particularly useful in connection with imaging an object such as a person's fingerprint. The invention is described herein in connection with a sensor for imaging a person's fingerprint, but it will be clear to those skilled in the art that the invention can be used for various applications where it is important to sense and image an object having surface features that can be measured with such a sensor.

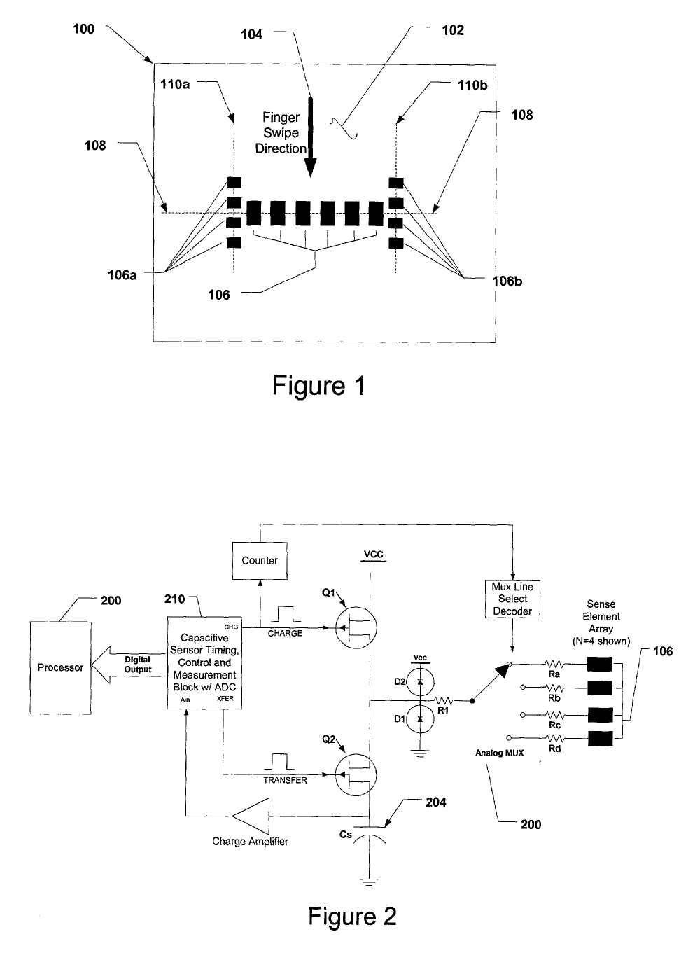

FIG. 1 schematically illustrates a sensor 100 constructed according to the principles of the present invention. The sensor 100 includes a surface 102 configured to enable an object such as a person's finger to slide thereon in a predetermined direction. In FIG. 1, the direction arrow 104 illustrates the direction that a person's finger would slide along the surface 102. For simplicity, the conductive PCB connections and planar (e.g., ground plane) features are not shown, though it s implicit in this schematic illustration that the sensor elements shown in FIG. 1 are connected to the sensing electronics.

An array of contact sense elements 106 are disposed on the surface 102. Each contact sense element produces data corresponding to a single pixel of an image. In FIG. 1,the contact sense elements 106 are configured to form a single linear array located on a first axis 108 oriented transverse to the direction 104 in which a finger would slide along the surface 102. Moreover, at least one additional sense element is located on a second axis which is orthogonal to the first axis 108. In FIG. 1, there are additional sense elements 106a, 106b, each disposed at the end of the single linear array located on first axis 108, and each disposed on a respective second axis 110a, 110b. The second axes 110a, 110b are parallel to each other, and each is orthogonal to the first axis 108.

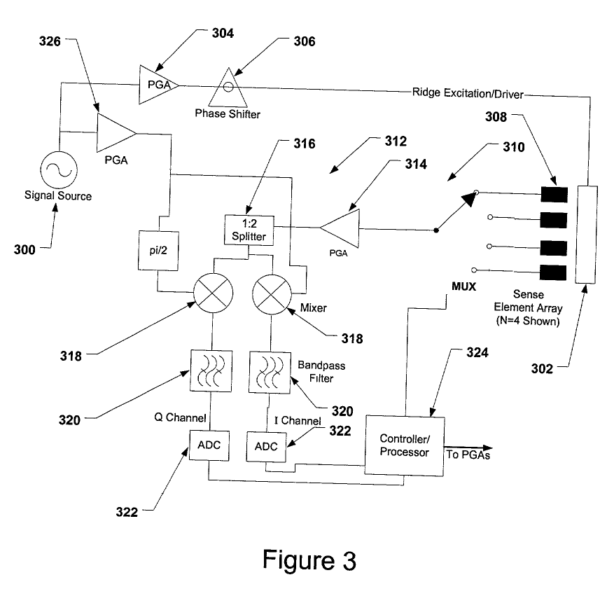

Each of the contact sense elements 106 is configured to produce data corresponding to a single pixel of an image, as an object such as a finger slides across the array of contact sense elements. Additionally, a scanning device (preferably a raster scan device) is configured to provide a periodic scan (i.e. a raster scan) of the array of contact sense elements 106, as described further in connection with FIG. 2.

While FIG. 1 illustrates the single array of contact sense elements 106 as a linear array, it is contemplated that the single array of contact sense elements could be in a curvilinear configuration. Thus, reference to contact sense elements being in a “single array” means that a single line of contact elements extends across the surface in a predetermined configuration, such that an object such as a finger slides along the surface in a direction generally transverse to the single line of contact sense elements. Moreover, while the additional contact sense elements (106a, 106b) are shown as disposed on axes which are orthogonal to the first axis (i.e. axes 110a, 110b are orthogonal to axis 108), they may not have to be perfectly orthogonal, so long as the additional sense elements are spaced from the single array of contact sense elements in a manner that enables a velocity measurement of the object, as it slides past the array of contact sense elements in a direction generally transverse to the single array of contact sense elements.

A processor 200 (FIG. 2) is in circuit communication with the raster scan device, and is configured to receive data from the raster scan device and to produce image and velocity data related to the object. The processor can be, e.g., a digital signal processor or virtually any processor that is designed for a desktop computer. As described further in connection with FIG. 2, the image and velocity data is used to reconstruct an image of the surface of the object which slides along the surface 102. Thus, when the object is a person's finger, the image and velocity data are used to reconstruct an image of the person's fingerprint.

FIG. 2 schematically illustrates the circuitry for providing a raster scan of the linear array of contact sense elements. For illustration purposes only, four sense elements 106 are shown. The array of contact sense elements 106 are raster-scanned as a finger slides over the contact sense elements 106 and samples are collected by a capacitance measuring technique, which includes an analog multiplexer 202, and an analog capacitance sensor 204 with accompanying analog to digital conversion electronics. While FIG. 2 shows a raster scan of a single linear array of the contact sense elements 106, when the preferred array of contact elements of FIG. 1 is used, the raster scan would also include the additional sense elements 106a, 106b as these additional elements can enhance the robustness of the velocity estimates derived therefrom. The data from the raster scans would be directed to processor 200, and processed to produce the image and velocity data related to the surface of the object which is being looked at.

The two major components of the sensor are the PCB with embedded contact sense elements and an application specific integrated circuit (ASIC), e.g. as shown in FIG. 2, that embodies the analog and digital electronics needed to multiplex and measure the capacitance at each sense element. An ASIC is not required for making the required measurements, but this is a common embodiment of such electronics. In the incoherent circuit of FIG. 2, sensing is facilitated by switching field effect transistors (FETs) Q1 and Q2, with Q1 providing charge injection, and Q2 providing charge transfer from the sensor to Cs (204), the capacitor that is used to store the charge retained by a sense element that indicates the capacitance at the location of that sense element. The sensor core 210 provides digital and analog control circuitry needed to implement the optimal switch timing, error correction and signal optimization needed for digitizing the analog sample optimally. The digitizing process is here shown as an embedded function of the process, though it may be determined that this is most cost effective as a separate component.

The circuit technology of FIG. 2 can be constructed by largely commercial off the shelf technology (COTS). The same can be said for the analog to digital conversion and multiplexer elements. In the circuit of FIG. 2, the Sensor Core Block 210, designated “Capacitive Sensor Timing Control and Measurement Block with ADC”, is a commercial product made by Quantum Research Group Ltd., 651 Holiday Drive, Body 5/300, Pittsburgh, Pa 15220 (e.g., the part sold under the mark QProx and part number QT9701B2). Using this particular integrated circuit is not the only way to implement the invention, but represents the class of technology that is amenable to successful implementation.

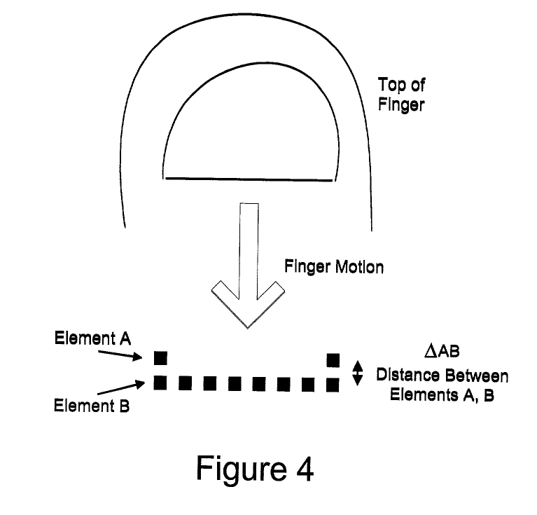

Also, while the approach shown of injecting, storing and measuring electric charge is consistent with the COTS ASIC shown, it is anticipated that, in some circumstances, it will be advantageous to use alternate topologies (e.g., also available from Quantum Research Group or its competitors). Such alternate topologies would use separate injection and storage elements. Thus, akin to the approach of FIG. 3, the charge injection FET Q1 in FIG. 2 could be used to drive a ridge excitation element like the element 302 of FIG. 3. The capacitance sensor may be implemented by coherent and incoherent COTS technology. By coherent is meant the fact that the measurement of capacitance is achieved by measuring the variation of radio frequency (RF) signal (phase/amplitude) for live tissue charge that is modulated by an oscillator (the oscillator would be part of the sensor assembly). The incoherent approach which is disclosed in FIG. 2, would not consider the phase of signals at all, but would rather make a direct measurement of the ability of the contact sense elements to retain a predetermined amount of charge by placing charge onto the contact sense elements by means of an applied electric field, and simply measuring the amount of charge transferred after the applied field is removed.

An example of a coherent sensor is shown in FIG. 3. For this type of sensor, the operation is as follows: a) a radio frequency (RF) signal source 300 drives a ridge excitation element (vertical bar 302 in FIG. 3) through a programmable gain amplifier 304 (PGA) and a phase shifter 306 that control the excitation signal level and phase, respectively; b) a contact sense element array that includes a single array of contact sense elements 308 extending transverse to the direction of motion of the finger, which serves as the signal pickup for the ridge excitation element and is connected element-wise to an analog multiplexer 310 (MUX) that allows for the measurement of the signal level and phase of the excitation signal as measured at the selected contact sense element; c) an in-phase/quadrature (I-Q) detector 312 comprising a PGA 314 (for controlling the signal level at the mixer), 1:2 signal splitter 316, RF mixer 318 , bandpass filter 320 and analog to digital converter 322 (ADC) for each of the split signal paths (I and Q); d) a microcontroller and/or signal processor 324 that reads the digital data at the output of the ADCs and stores it in a memory buffer for subsequent processing. The I and Q channels are determined at the mixers by providing an in-phase (0 degrees phase shift) and quadrature (90 degrees or pi/2 radians) version of the signal source, also controlled through a PGA 326 for setting the appropriate level at the mixer.

The coherent sensor processing involves combining the coincident I and Q data into a complex data element (i.e., having real and imaginary parts), one per pixel (4 pixels are shown), and then integrating (adding) successive same-pixel data measurements until the per-pixel signal to noise ratio requirements are met. Alternately, the electronics might be designed so that the integration of per-pixel data is achieved with analog electronics (e.g., the bandpass filter or an equivalent integrating element), so that only one sample per pixel is needed at the ADC 322. In either case, the data that will result from integrating and sampling or sampling and integrating signal from each pixel (one per analog mux channel) will be the same: a one-dimensional complex data vector containing pixel data having phases and amplitudes modulated by the ridge structure across one transect (the line across the finger formed where the sense element array comes in contact with the fingerprint). The amplitude and phase modulation per pixel will differ for the case where a ridge is in contact with the sense element as compared to when a ridge is not in contact with the sense element. The contrast generated by this differential measurement constitutes a one dimensional line image of the ridge structure for that transect of the fingerprint.

Again, as with the incoherent approach shown in FIG. 2, this coherent measurement approach can be implemented with differing topologies, depending on the particular components selected to realize its function. For instance, there are COTS ASICs that embody the entire I-Q detection block of FIG. 3, and these may be advantageous to some applications.

Processing of the image and velocity data, and reconstruction of the image, will be heavily dependent on spatial or frequency domain vector arithmetic that facilitates a line-by-line correlation between raster scans, augmented with data from the additional sense elements orthogonal to the single array of contact sense elements. The bulk of the signal processing computes two dimensional correlates from the ensemble of 1D data collected as the finger is “swiped”. These correlates will be computed in the sensor processor (e.g., 200 in FIG. 2, 324 in FIG. 3) or an equivalent computing resource separate from the sensor electronics.

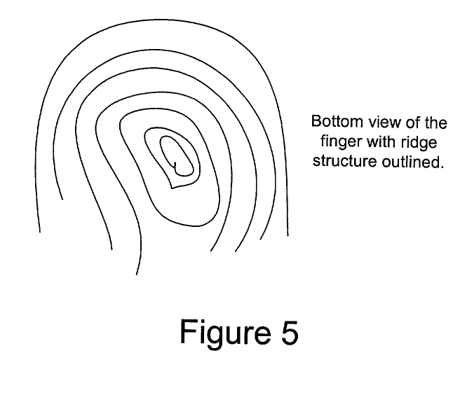

With the sensor geometry of FIGS. 1 or 4, the single array of contact sense elements, e.g. elements 106 in FIG. 1, would represent a majority of the sense elements, and will likely be on the order of 100 elements per device. These elements will provide the 1 D data needed to reconstruct a fingerprint. The additional contact service elements, e.g. elements 106a, 106b, will measure the velocity at several points across the 1D array (two points are shown in FIGS. 1 and 4) and this velocity will be used to combine the multiple 1D images into an accurate composite 2D image of the fingerprint. Measuring velocity at multiple points across the swiped object allows for better correction of rotation of the swiped object, if such motion occurs. By using the orthogonal arrangement shown in FIGS. 1 and 4, the measurement of correlates between scans through the array of sense elements can readily be used to measure the fingerprint features and estimate the motion of the finger so as to provide a means for reconstructing a high fidelity 2D image from 1D measurements.

As an example, using a sensor geometry like that of FIG. 4, the 2D image acquisition might proceed as follows:

1. Select contact sense elements are continuously monitored for bulk capacitance and adequate signal energy in the spatial frequency band of fingerprint ridges until the presence of a finger is detected (the bulk capacitance increases substantially across many samples)

2. Sample a single linear array of, e.g., 100 contact sense elements (pixels), e.g., at frequencies on the order of a 1 Mhz rate, or 1 microsecond per pixel, yielding a scan rate of 10 kHz.

3. Use cross correlates of the high signal to noise ratio elements of the vertically oriented additional sense elements (e.g. the elements A and B in FIG. 4) to estimate vertical velocity as a function of vertical position. Cross correlation is used in the following way to measure velocity:

a. Data time series of adjacent pixels are formed for pixels that are aligned with the direction of motion, i.e. the pixels associated with contact sense elements A and B in FIG. 4.

b. Based on the sampling rate and the known limits of motion for the finger (i.e., nonzero, but bounded by reasonable usage limitations at humanly possible velocities) segments from each time series are selected.

c. In order to select segments from one time series and (eventually) correlate it with segments from another time series, one time series is used as a reference time series and the other is a comparison time series, collected at the reference and comparison pixels, respectively. Each data point in the time series is representative of a particular point in time for the sweeping of the finger.

d. To compute the velocity at a given point in time, a segment from this given point in time is selected from the reference time series about the data point collected at this point in time; this is the reference segment. Same-size segments are then selected from the comparison time series about the same point in time as the reference segment, and these are correlated with the reference segment. Thus, in FIG. 6, either the contact sense element A data or the contact sense element B data is the reference time series, and the other contact sense element data is the comparison time series.

e. The segment from the comparison series that shows the highest correlation (as represented by the value of the dot product of the two vectors) is the segment that corresponds to the same physical region in the finger ridge structure as that represented by the reference segment. This is the matching comparison segment. In FIG. 6, the comparison time segments are those that include points A1, B1.

f. Ideally, the location of the point of maximum correlation would merely involve searching amongst the correlate data for a simple maximum.

However, in practice, significant improvement in performance can be obtained if the correlate data are fitted to a function (e.g., sin(x)/x, an approximation to the same or similar), and solving for the location of the maximum of the fitted function, which will be a more robust estimate of the location of maximum correlation.

g. The time difference between the center of the matching comparison segment and the reference segment is equal to the amount of time that passed between the time the finger region corresponding to the reference segment contacted the reference pixel and the time it contacted the comparison pixel.

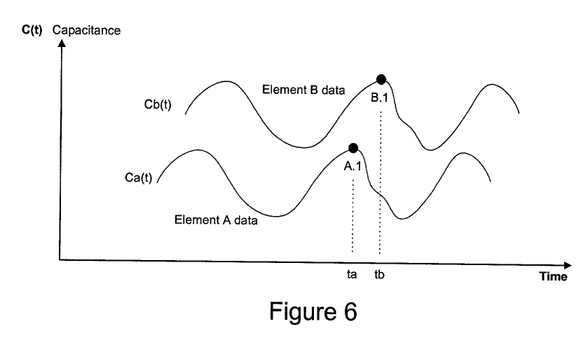

h. Since the distance between the reference and comparison pixels is known, and since the elapsed time for the motion of the finger between these two points is known, the velocity for that point in time for that region of the finger is simply the distance between the pixels divided by the time difference measured through segment correlation. Thus, in FIGS. 4-6,

ta, tb=times at which the same point passed elements A,B respectively (shown at A.1, B.1 in FIG. 6)

Calculation of the finger velocity in the vicinity of time t=ta is given by velocity=distance/time=ΔA AB/(tb-ta)

Where tb-tb is estimated by cross correlating data about A.1 and B.1 from Ca(t) and Cb(t) respectively

i. If this process is repeated for each point in time during the swiping motion of the finger past the sense element array, the velocity as a function of time can be estimated for the portion of the finger associated with the sense elements (pixels) used to form the reference and comparison time series.

j. Since the time intervals between the velocity estimates thus formed are known, the velocity data can be used to compute a position, by integrating the velocity data with respect to time.

4. Use cross correlates of the high signal to noise ratio elements of the single array of contact sense elements (e.g. the horizontal contact sense elements in FIG. 4) to estimate horizontal velocity (i.e. velocity transverse to the finger swipe direction) as a function of vertical position.

5. Grid pixels from the 1D vectors (placed into output image bins according to the position integrated from the horizontal and vertical velocity measurements) until the sweep of the finger is complete, as indicated by the monitoring of the apparent bulk capacitance and ridge spatial frequency energy, or when allotted image memory storage has been exhausted.

It should be further noted that when sense elements are located at both ends of the single linear array (i.e. in the configuration of FIGS. 1 and 4), the data provided by those additional sense elements can be further used to determine if an object such as a person's finger is rotating as it is sliding along the surface.

Additionally, it is useful to apply a material such as Parylene (produced by Specialty Coating Systems, Indianapolis, Indiana) at lease to the part of the PCB substrate carrying the contact sense elements, in a thickness of about 0.001 inches, to reduce wear and tear of the sensor, and to further protect the sensor against ESD.

Thus, according to the foregoing detailed description, a new and useful sensor has been provided, which is particularly useful in providing data for imaging the surface of an object such as a fingerprint. The preferred form of the present invention, using PCB type of contact sensors, is designed to address all of the types of issues (e.g. ruggedness, ESD susceptibility, contamination, and cost) which are often associated with silicon based contact sensors. Moreover, the principles of the present invention, if applied to silicon based contact sensors, may also provide some improvements, e.g. in terms of cost and ruggedness. Specifically, the principles of the present invention, if implemented with a silicon based contact sensor, should minimize the number of contact sensors needed, and that should translate into cost savings and improvement in the ruggedness of the sensor. With the foregoing disclosure in mind, it is believed that various applications of the principles of the present invention will be apparent to those skilled in the art.

1. A sensing device for use in imaging surface features of an object, comprising
a. a surface configured to enable an object to slide thereon in a predetermined direction,
b. an array of contact sense elements disposed on said surface, and configured to form (i) a single array of contact sense elements oriented transverse to said predetermined direction and (ii) at least one additional contact sense element in spaced relation to the single array of contact sense elements in a manner that enables a velocity measurement, each contact sense element configured to produce data corresponding to a single pixel of an image,
c. a scanning device configured to provide a scan of the array of contact sense elements, and
d. a processor in circuit communication with said scanning device and configured to receive data from said scanning device and to produce image and velocity data related to the object.

2. A sensing device as defined in claim 1, wherein all of said contact elements comprises electrically conductive elements disposed on a polymeric substrate formed of a material from a class comprising polymers and ceramics.

3. A sensing device as defined in claim 1, wherein said single array of contact sense elements is configured as a single linear array of contact sense elements located on a first axis oriented transverse to said predetermined direction, and said additional contact sense element is located on a second axis which is orthogonal to said first axis.

4. A sensing device as defined in claim 3, including additional contact sense elements located at each end of said single array of contact sense elements.

5. A sensing device as defined in claim 1, including additional contact sense elements located at each end of said single array of contact sense elements.

6. A sensing device as defined in claim 1, wherein said array of contact sense elements, said scanning device and said processor are configured to (i) sense the presence of a portion of an object having a surface configuration which is desired to be imaged, (ii) scan the array of contact sense elements at a predetermined frequency, (iii) use the scan of the additional sense element to estimate velocity of movement of the object in the direction of movement of the object, and (iv) produce image data from the scan of the array of contact sense elements.

7. A sensing device as defined in claim 6, wherein image data transverse to the direction of movement of the object is provided from the single array of contact sense elements, and location of the image data in the direction of movement of the object is provided from the velocity of movement of the object in the direction of movement of the object.

8. A sensing device as defined in claim 7, wherein said array of contact sense elements, said scanning device and said processor are configured to the use the scan of the single array of contact sense elements to estimate movement of the object in the direction of the single array of contact sense elements, and to adjust the image data based on any such movement of the object in the direction of the single array of contact sense elements.

9. A sensing device as defined in claim 8, wherein said array of contact sense elements includes additional contact sense elements at the ends of said single array of contact sense elements, and said scanning device and said processor are configured to compare the velocity measurements from each of said additional contact sense elements to determine rotational movement of the object as it is moving in said predetermined direction, and to adjust said image data based on any such rotational movement.

10. A sensing method for use in imaging surface features of an object, comprising the steps of
a. providing a surface, and sliding an object along the surface in a predetermined direction,
b. providing an array of contact sense elements disposed on the surface, configured to form a single array of contact sense elements extending transverse to said predetermined direction and at least one additional contact sense element in spaced relation to the single array of contact sense elements in a manner that enables a velocity measurement in the direction of movement of said object, each contact sense element configured to produce data corresponding to a single pixel of an image,
c. providing periodic scans of the array of contact sense elements, as the object slides along the array of contact sense elements, and
d. processing the scan data to produce image and velocity data related to the object.

11. A method as set forth in claim 10, wherein said step of providing an array of contact sense elements comprises providing additional contact elements at both ends of the single array, producing from said additional contact sense element, velocity measurements in the direction of movement of the object and comparing such velocity measurements to determine rotational movement of the object as it is moving in the predetermined direction.

12. A method as defined in claim 10, wherein the array of contact sense elements is scanned at a predetermined frequency, the scan of the additional sense element is used to measure velocity of movement of the object in the direction of movement of the object, and image data is produced from the scan of the array of contact sense elements.

13. A method as defined in claim 12, wherein image data transverse to the direction of movement of the object is produced from the periodic scan of the single array of contact sense elements, and location of the image data in the direction of movement of the object is provided from the velocity of movement of the object in the direction of movement of the object.

14. A method as defined in claim 13, wherein the periodic scan of the single array of contact sense elements is used to estimate movement of the object in the direction of the single array of contact sense elements, and to adjust the image data based on any such movement of the object in the direction of the single array of contact sense elements.

15. A method as defined in claim 14, wherein said array of contact sense elements includes additional contact sense elements at the ends of said single array of contact sense elements, and the periodic scans of the additional sense elements is used to produce and compare the velocity measurements from each of said additional contact sense elements to determine rotational movement of the object as it is moving in said predetermined direction, and to adjust the image data based on any such rotational movement.
